(19) United States
(12) Patent Application Publication
(10) Pub. No.: US 2025/0055001 A1
(43) Pub. Date: Feb. 13, 2025

(54) ELECTROCHEMICAL APERTURE AND METHOD FOR RELIABLE, FAST ACTIVATION OF RESERVE BATTERIES

(71) Applicant: Faraday Technology, Inc., Englewood, OH (US)

(72) Inventors: Danny Xin Liu, Tipp City, OH (US); Timothy D. Hall, Englewood, OH (US); Maria E. Inman, Yellow Springs, OH (US); Holly M. Garich, Fairborn, OH (US); Earl Jennings Taylor, Bonita Springs, FL (US)

(21) Appl. No.: 18/755,001

(22) Filed: Jun. 26, 2024

Related U.S. Application Data
(60) Provisional application No. 63/518,609, filed on Aug. 10, 2023.

(51) Int. Cl. H01M 6/36; H01M 4/06; H01M 6/16

(52) U.S. Cl. CPC H01M 6/36; H01M 4/06; H01M 6/162

(57) ABSTRACT

A battery includes a first chamber with a first electrode and a second chamber with a second electrode. An intercalation membrane between the first chamber and the second chamber is configured to retain an electrolyte in the first chamber and to accept therein migrating ions of the electrolyte in the presence of an electrical field and lose mechanical integrity permitting the electrolyte to enter the second chamber in order to activate the battery.

### RELATED APPLICATIONS

This application claims benefit of and priority to U.S. Provisional Application Ser. No. 63/518,609 filed Aug. 10, 2023, under 35 U.S.C. §§ 119, 120, 363, 365, and 37 C.F.R. § 1.55 and § 1.78, which is incorporated herein by this reference.

### GOVERNMENT RIGHTS

This invention was made with U.S. Government support under Contract Nos. FA8650-19-P-2024 and FA8650-21-C-2300 awarded by the USAF/AFMC, AFRL Wright Research Site. The Government has certain rights in the subject invention.

### FIELD OF THE INVENTION

This subject invention relates to an electrochemical aperture for a long shelf-life battery such as a lithium-based reserve energy storage battery and method for reliable and rapid activation of lithium-based reserve energy storage batteries.

### BACKGROUND OF THE INVENTION

To achieve long shelf-life, reserve batteries have relied on the isolation of battery components to prevent premature degradation and parasitic reactions leading to self-discharge. The electrolyte is commonly the isolated component that requires storage and delivery to the anode and/or cathode for battery activation. Traditional reserve battery technologies can generally be classified as thermal, electrolyte/gas displacement, or spin-dependent, based on their respective activation mechanisms. These conventional battery designs are often encumbered with external ancillary components, contributing excess weight and volume towards the battery, and thus, significant penalties in specific energy and/or energy density. Some of these reserve battery activation mechanisms necessitate additional considerations for thermal management and other prerequisite activation conditions that constrain operating parameters and limit performance.

Compared to traditional aqueous-based batteries, lithium-based batteries offer an enticing path towards achieving significant improvements in energy density due to lithium's high theoretical capacity (3,860 mAh/g) and exceptional electrochemical potential (−3.04 V vs Standard Hydrogen Electrode reference potential). For the separation of electroactive components during storage, lithium-based reserve batteries have relied on (1) employing inorganic salt electrolytes that are non-conductive solids at ambient temperatures, categorized as “thermal-types” or (2) glass ampules or collapsible bellows, serving as “reservoir-type”, for liquid electrolyte storage. Accordingly, activation of the “thermal-type” reserve batteries requires the application of enough heat supplied by pyrotechnic materials to melt the inorganic salt electrolyte, thus facilitating ionic conduction and enabling typical battery operation. Alternatively, the activation of “reservoir-type” reserve batteries involves mechanical force or gas pressure to release/displace the liquid electrolyte from the ampules or bellows to the anode and cathode contained in an adjacent compartment.

Although lithium-based reserve batteries offer unparalleled reliability, significant energy density penalties of up to 50% are incurred due to the design necessitated by the storage and activation mechanisms. The ancillary components involved in electrolyte storage and delivery (ampule, bellows, diaphragms, manifolds, pyrotechnic initiators, thermal insulation, and the like) contribute excess volume, mass, and complexity that detrimentally impact specific/volumetric energy density. Increased complexity can arise when ruggedized reserve battery designs are required. Conventional glass ampules containing the liquid electrolytes, are activated by shattering the glass via acceleration force or squib-induced explosive output. However, mishandling during battery transport or installation can inadvertently break the glass ampule, thus prematurely activating and invalidating the reserve battery. Efforts to combat premature activation involved ruggedizing the ampule design by replacing glass with copper ampules, which necessitated a corresponding cutter for breaking the copper ampule to release the electrolyte. Although the inclusion of the copper ampule and cutter has improved the robustness of the reserve battery, it also detrimentally contributes excess mass, volume, and complexity with the addition of the “moving-part” cutter.

Additionally, the activation mechanisms can place constraints on operational performance. For example, the operational life of an activated “thermal-type” reserve battery is constrained by duration in which the pyrotechnic heat source can sustain the melted electrolyte in liquid, ionically-conductive form. The brief window of time in which activated “thermal-type” reserve batteries may supply power is limited from a few seconds to over an hour. This technical constraint essentially limits contingency options upon activation and would irreversibly “start the clock”, requiring use of the activated reserve battery before the pyrotechnic heat source depletes, resulting in electrolyte re-solidification.

### BRIEF SUMMARY OF THE INVENTION

Provided is an improvement in the electrolyte storage, separation, and delivery mechanisms for robust lithium reserve batteries. This new design paradigms that enables long-term storage and rapid electrolyte delivery, with negligible mass/volume contributions, and minimal constraints on post-activation operational performance vastly improves the efficacy, reliability, and versatility of lithium-based reserve batteries.

To address these challenges inherent in current based reserve batteries, disclosed is an electrochemical aperture that enables the safe, reliable, on-demand, all-inclusive, remote-capable, storage/delivery of liquid electrolytes to enable activation of lithium-based reserve batteries with no-moving-parts. As evidence from the description and examples herein, analogous elements from the traditional reserve battery are incorporated into the instant invention.

Disclosed is a device for storing and on-demand release of electrolytes involving an electrochemical aperture which may be open or closed. The closed electrochemical aperture contains or confines the liquid electrolyte to one chamber of the reserve battery. The open electrochemical aperture permits passage of liquid electrolyte from the chamber of the reserve battery to another chamber of the reserve battery. In this manner, the reserve battery switches from the reserve or storage mode to the active or power generating mode.

The problem of providing a reliable, long shelf-life, robust reserve energy storage battery unencumbered with complex activation mechanisms, where the initially isolated electrolyte is introduced through heat or physical force to enable battery operation, and thus requiring sophisticated or bulky hardware, leading to weight and volumetric energy density penalties and/or potentially unreliable performance is solved by a lithium-based reserve battery with an “electrochemical aperture”, that is either unsupported or supported (e.g., on a mesh structure), and sufficiently thin to allow for rapid activation while maintaining sufficient mechanical integrity needed to isolate the electrolyte and includes a material capable of reacting with ions of the electrolyte whose function includes separating two compartments wherein the electrolyte is confined to one compartment during storage and said reserve battery is rapidly activated preferably in less than 5 s and more preferably less than 1 s by applying an electric field and preferably a pulsed electric field to the electrochemical aperture which may be preconditioned by intercalation to the point of maintaining sufficient mechanical integrity to isolate the electrolyte wherein minimal additional intercalation results in actuation of the electrochemical aperture and delivery of the electrolyte to the other compartment thereby activating the reserve storage battery preferably with no-moving-parts.

Featured is a battery comprising a first chamber with a first electrode, a second chamber with a second electrode, and an intercalation membrane between the first chamber and the second chamber. The membrane is configured to retain an electrolyte in the first chamber and to accept therein migrating ions of the electrolyte in the presence of an electrical field and lose mechanical integrity permitting the electrolyte to enter the second chamber.

In one example, the first electrode is a cathode, the second electrode is an anode, the electrolyte is a lithium containing catholyte, the migrating ions are lithium ions, and the first electrode and second electrode include lithium.

The intercalation membrane may include aluminum foil. A power source can be connected to the intercalation membrane for generating the electrical field and a switch can be used to selectively connect the intercalation membrane to the power source.

The battery may further include supports for the intercalation membrane. The first electrode may include a first connector and the second electrode includes a second connector for first and second load leads, respectively once the battery is activated. The battery may further include a battery separator between the first electrode and the second electrode for allowing ions of the electrolyte to pass bidirectionally between the first and second electrodes. The membrane can be pre-calcilated with the ions. The intercalation membrane can be configured to de-calcilate in the presence of the electrical field and lose mechanical integrity permitting the electrolyte to enter the second chamber.

Also featured is a reserve battery comprising a first electrode, a second electrode, an electrolyte, and a membrane between the first electrode and the second electrode. The membrane is configured to have two states: a first cohesive state blocking said electrolyte from contacting the second electrode and a second losing cohesion state permitting pass-through of the electrolyte to the second electrode. A power source is connectable to the membrane to change the membrane from the first state to the second state to deliver the electrolyte to the second electrode to activate the battery when needed to provide power.

In the second state, the membrane is injected with ions, has ions removed from it, or is electrochemically oxidated or dissolutioned.

Also featured is a method of activating a battery. A cohesive membrane is placed in the battery to define first and second chambers each including an electrode. An electrolyte is placed in the first chamber. An electrical field is applied to the membrane until it loses cohesion so the electrolyte can pass from the first chamber into the second chamber providing power access to the electrodes. Preferably, applying the electrical field causes ions to inject into the membrane, causes ions to leave the membrane, or electrochemically oxidizes or causes dissolution of the membrane.

Preferably, a power source connected to the membrane generates the electrical field. The method may further include selectively connecting the membrane to the power source, supporting the intercalation membrane, placing a battery separator between the electrodes and allowing ions of the electrolyte to pass bidirectionally between the first and second electrodes and/or pre-calcinating the membrane with said ions.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A shows an example of a closed electrochemical aperture;

FIG. 1B shows an example of a closed electrochemical aperture with wire mesh supports;

FIG. 2 is a schematic view of an example of a reserve battery in the storage mode;

FIG. 3 is a schematic view of an example of a reserve battery invention in the power delivery mode;

FIGS. 4A-4B illustrate one manner of activating the reserve battery by injection of lithium ions into the closed electrochemical aperture;

FIGS. 5A-5B illustrate another manner of activating the reserve battery by removal of lithium ions from the closed electrochemical aperture; and

FIGS. 6A-6B illustrate another manner of activating the reserve battery by removing metal ions from the closed electrochemical aperture.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

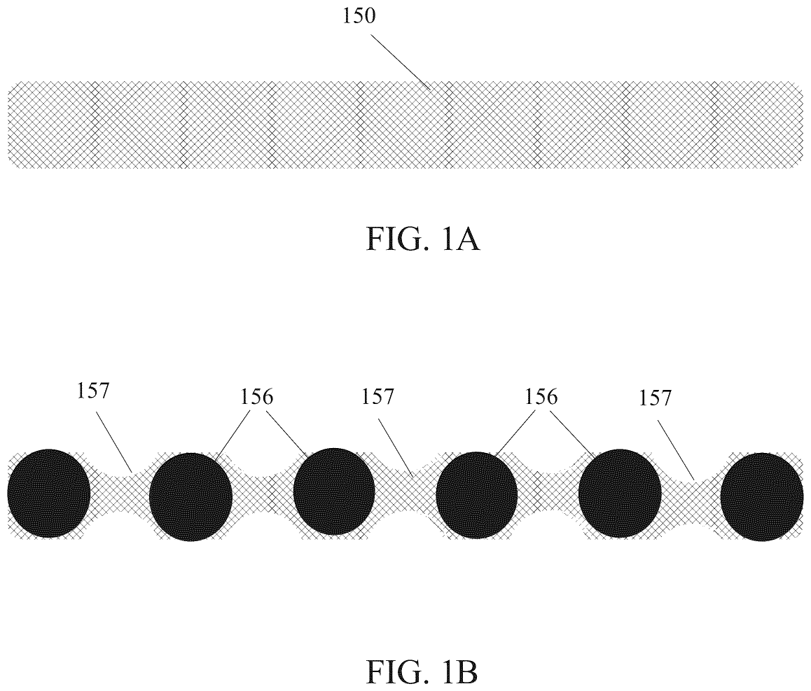

FIG. 1A is an illustration of a closed electrochemical aperture 150. In one example, the preferred closed electrochemical aperture 150 is made of a material that can accept or release lithium ions under the influence of an electrochemical current or potential. The lithium accepting or releasing material may include tin or tin alloys, aluminum or aluminum alloys and the like. The closed electrochemical aperture 150 may be supported by wire mesh supports 156.

In FIG. 1B, as apparent in the examples which follow, the benefits of the use of wire mesh supports 156 facilitates the use of closed electrochemical aperture 150 with thin regions 157 enabling rapid activation of a reserve battery. The wire mesh support 156 material may include copper or copper alloys or steel or variants of steel or nickel and nickel alloys or other materials stable in the reserve battery electrolyte. The wire mesh support 156 material can be selected based on cost, ease of manufacture and chemical or electrochemical compatibility with the reserve battery electrolyte. A mesh could more broadly be interpreted as a screen or similar form factor.

An electrodeposition process can be manipulated to provide uniform Sn supports through enhanced control of the electrodynamic boundary layer across the surface of the membrane. By adjusting the waveform parameters to produce an electrodynamic boundary layer that conforms to the membrane surface features, a uniform deposit can be obtained. Waveform parameters can also be tuned to provide exaggerated key-hole features between the wires of the metal mesh, creating regions of relatively thin Sn support films. A DC electrodeposition process produces a thick Sn film, a subsequent DC etch provides some thinning of the aperture film, or in contrast the use of an electrodeposition process produces a much thinner region 150, which may enable a more rapid rupture and battery activation process.

Conceptually, the electrochemical aperture or intercalation membrane serves as a “door” between a first electrode chamber and a second electrode chamber. To increase the shelf life of the battery, the “door” is closed and the electrolyte is constrained to one chamber only.

To use the battery to power a load, an electrical field is applied to the intercalation membrane whereupon electrolyte ions intercalate or migrate from the electrolyte into the intercalation membrane causing the intercalation membrane to eventually lose structural or mechanical integrity (it becomes filled with holes or bursts in part, or the like) and thus the “door” opens. When that happens, the electrolyte enters the other chamber and now the battery operates to power a load connected across the electrodes.

The battery, as is common, may include a separator between the first and second electrodes allowing ions of the electrolyte to pass bidirectionally between the first and second electrodes when the electrolyte enters the other chamber for charging and discharging the battery without an electrical short.

In one embodiment, the membrane is pre-intercalated to shorten the time it takes to lose mechanical integrity when the electrical field is applied. In one embodiment, the battery is a lithium-ion battery. Other electrolyte species includes those with H, Na, K, and/or Mg ions and perhaps others.

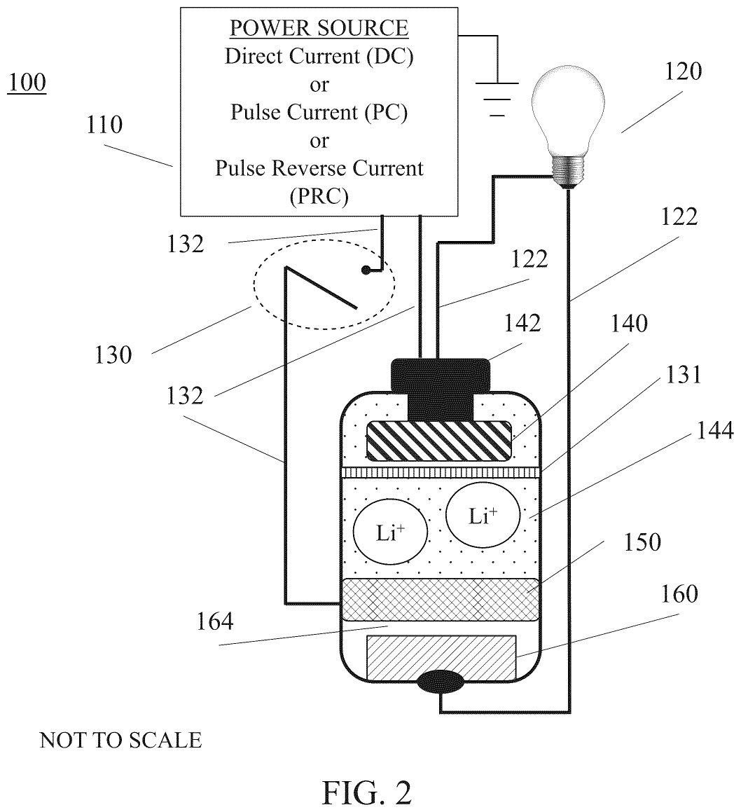

In FIG. 2 is an illustration of the reserve battery 100 of the instant invention in the power storage mode. The system includes a power source 110 for activating the reserve battery 100 with an open activation switch 130 and activation leads 132. This reserve battery 100 includes a lithium containing cathode 140 with a cathode connector 142 and a lithium containing catholyte 144. The reserve battery 100 includes a lithium containing anode 160 with an anode connector 162 and an electrolyte-free anolyte chamber 164. Separator 131 may be included. The electrolyte-free anolyte chamber 164 is understood to be in proximity to the lithium containing anode 160. Cathode 140 replenishes lithium ions in the electrolyte.

In the power storage mode, the inactive load 120 is connected to the lithium containing cathode 142 and lithium containing anode 160 with load leads 122. In the storage mode the closed electrochemical aperture 150 prohibits the lithium containing electrolyte 144 from flowing into the electrolyte-free anolyte chamber 164. The lithium containing catholyte 144 is understood to be in proximity to the cathode 140.

The closed electrochemical aperture 150 is preferably a material that can accept or release lithium ions under the influence of an electrochemical current or potential. The closed electrochemical aperture 150 may include wire mesh supports 156 (not shown). Electrodes within any battery must be physically separated by a separator 131, typically by a porous polymer membrane. Physical separation of the lithium containing cathode 140, the closed electrochemical aperture 150, and lithium containing anode 160 is ideal. However, physical separation between the closed electrochemical aperture 150 and the lithium containing anode 160 is not a requirement for the reserve battery 100 of the instant invention to activate.

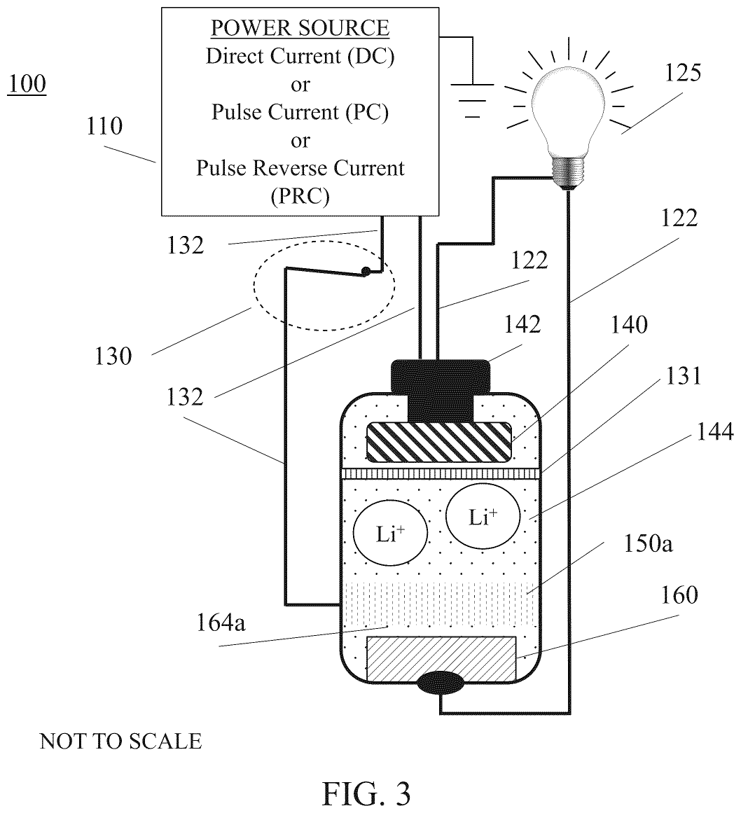

In FIG. 3 shows a reserve battery 100 in the power delivery mode after activation by closing switch 130 and causing electrolyte ions to migrate to aperture 150 causing it to lose integrity. In the power delivery mode, the active load 125 is connected to the lithium containing cathode 142 and lithium containing anode 160 with load leads 122. In the power delivery mode, the now open electrochemical aperture 150a permits the lithium containing electrolyte 144 to flow through and form a lithium containing anolyte chamber 164a.

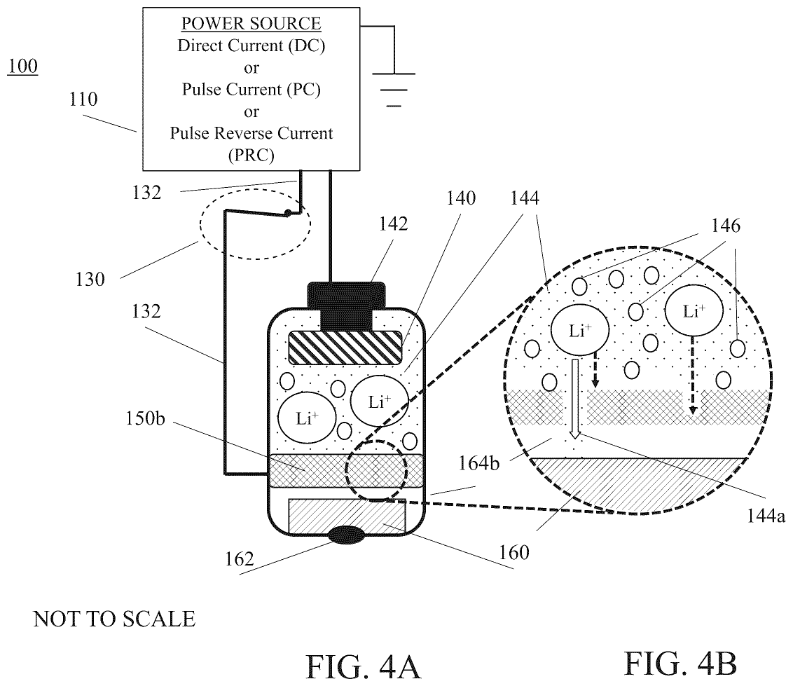

As illustrated in FIGS. 4A-4B, while not bound by theory, the reserve battery 100 may be activated by injection of lithium ions into the closed electrochemical aperture 150b. Although not shown in FIGS. 4A-4B, the electrochemical aperture 150b may include wire mesh supports. Injection of lithium ions results in the open electrochemical aperture 150a by rupture of the closed electrochemical aperture 150b. As made clearer in the examples herein, the closed electrochemical aperture 150b may be preconditioned or more specifically pre-lithiated, that is, pre-loaded with lithium ions while still maintaining its mechanical integrity. The electrochemical aperture may be pre-lithiated in situ prior to switching the reserve battery 100 to the power storage mode. Pre-lithiation of the closed electrochemical aperture 150b facilitates rapid rupture and may decrease the time required for activation of the reserve battery 100. Power source 110 delivers a direct current or voltage, or pulse current or voltage, or pulse reverse current or voltage to the cathode 142 and the closed electrochemical aperture 150b through closed activation switch 130 and activation leads 132. The activation injects lithium ions into the closed electrochemical aperture 150b resulting in a partially open electrochemical aperture 150b and a partially filled anolyte chamber 164b. In addition to the injection of lithium ions into the aperture the activation process could generate gas bubbles 146. Generation of gas bubbles 146 may speed the rupture of the closed electrochemical aperture 150b. After a sufficient activation time the reserve battery is in a power delivery mode as illustrated in FIG. 3.

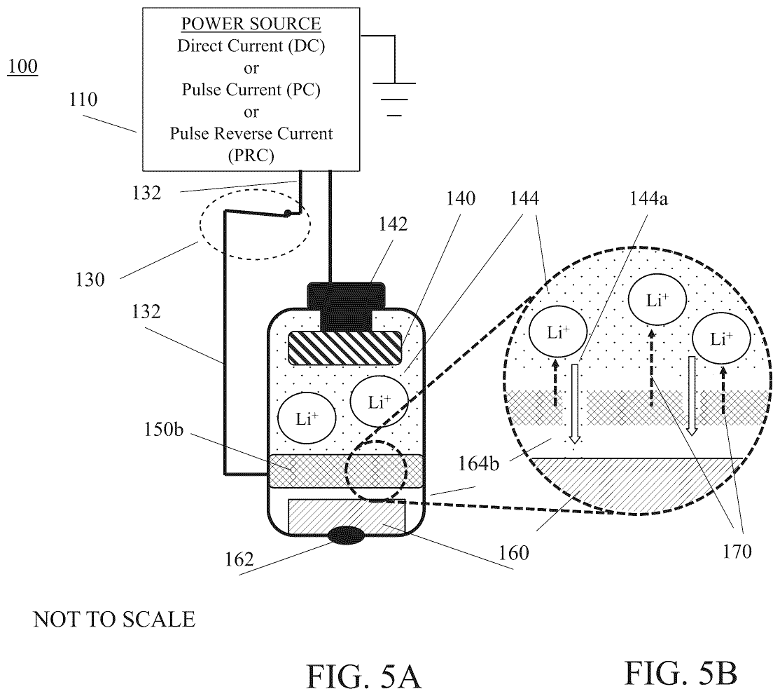

As illustrated in FIGS. 5A-5B, while not bound by theory, the reserve battery 100 may be activated by removal of lithium ions, that is de-lithiation from the closed electrochemical aperture 150b which has been pre-lithiated. Although not shown in FIGS. 5A-5B, the electrochemical aperture 150b may include wire mesh supports 156. The electrochemical aperture may be pre-lithiated in situ prior to switching the reserve battery 100 to the power storage mode. De-lithiation of the pre-lithiated closed electrochemical aperture 150b induces holes resulting in an open electrochemical aperture 150b allowing flow of electrolyte into partially filled anolyte chamber 164b through ionic pathways indicated by arrows 144a. Power source 110 delivers a direct current or voltage, or pulse current or voltage, or pulse reverse current or voltage to the cathode 142 and the closed electrochemical aperture 150b through closed activation switch 130a and activation leads 132. The activation removes lithium ions from the closed electrochemical aperture 150b as shown by arrow 170 resulting in a partially open electrochemical aperture 150b and a partially filled anolyte chamber 164b. After a sufficient amount of activation time the reserve battery is in a power delivery mode as illustrated in FIG. 3.

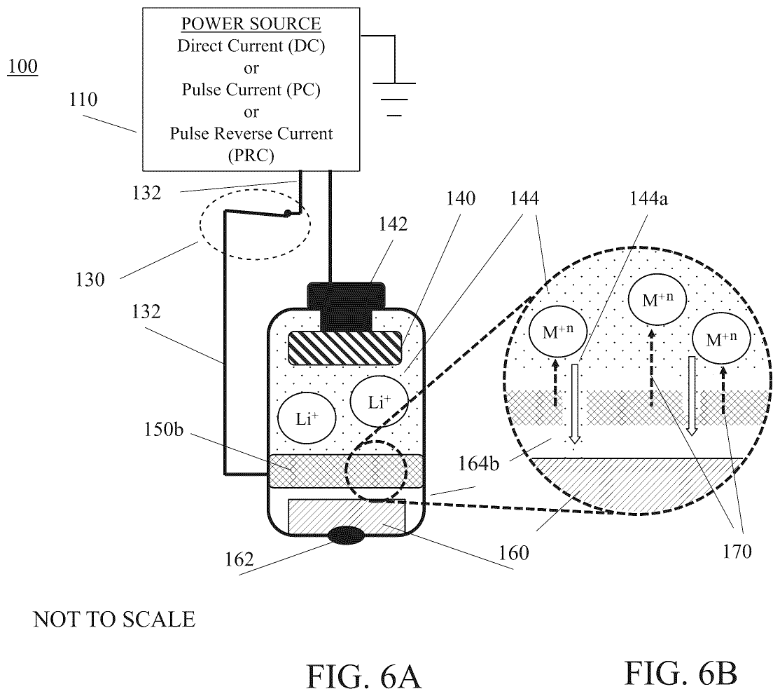

As illustrated in FIG. 6A, the reserve battery 100 may be activated by electrochemical oxidation or dissolution of the electrochemical aperture 150b wherein the metallic electrochemical aperture 150b comprises metals such as tin, copper or other material subject to electrochemical oxidation or dissolution. Although not shown in FIG. 6A the electrochemical aperture 150b may include wire mesh supports. Electrochemical oxidation of the closed electrochemical aperture 150b induces holes resulting in an open electrochemical aperture, FIG. 6B, allowing flow of electrolyte into partially filled anolyte chamber 164b through ionic pathways indicated by arrows 144a. Power source 110 delivers a direct current or voltage, or pulse current or voltage, or pulse reverse current or voltage to the cathode 142 and the closed electrochemical aperture 150b through closed activation switch 130a and activation leads 132. The activation removes lithium ions from the closed electrochemical aperture 150b as shown by arrow 170 resulting in a partially open electrochemical aperture 150b and a partially filled anolyte chamber 164b.

### Working Example I

A reserve battery 100 of the instant invention with a closed aperture 150b consisting of 16 μm aluminum foil (Reynolds, 96-98.5%), aperture in a disc diameter of approximately 1.2-1.3 cm containing a lithium containing catholyte 144 consisting of 1M LiPF₆ in a 3:7 volume mixture of ethylene carbonate and ethyl methyl carbonate, respectively (MTI Corp) and a lithium containing cathode 140, LiFePO₄ (MTI Corp 93% loading). The power source 110 was used to apply a current or voltage, through closed activation switch 130 and activation leads 132, between the lithium containing cathode 140 and the closed electrochemical aperture 150b to initiate formation of openings in the electrochemical aperture 150b.

TABLE I
Summary of activation times using a 16 μm
thickness aluminum foil electrochemical aperture

| Applied | | | | | Average | |
|---|---|---|---|---|---|---|
| Voltage | Trial # | | | | Activation | Standard |
| (V) | 48-1 | 48-2 | 48-3 | 48-4 | Time (s) | Deviation (s) |
| −5 | Activation times (seconds) | | | | 303.0 | 79.2 |
| | 188 | 324 | 331 | 369 | | |

| Applied | | | | | Average | |
|---|---|---|---|---|---|---|
| Voltage | Trial # | | | | Activation | Standard |
| (V) | 47-1 | 47-2 | 47-3 | n/a | Time (s) | Deviation (s) |
| −11 | Activation times (seconds) | | | | 305.0 | 49.1 |
| | 356 | 258 | 301 | n/a | | |

| Applied | | | | | Average | |
|---|---|---|---|---|---|---|
| Voltage | Trial # | | | | Activation | Standard |
| (V) | 44-1 | 45-1 | 45-2 | 45-3 | Time (s) | Deviation (s) |
| −15 | Activation times (seconds) | | | | 539.3 | 190.9 |
| | 763 | 633 | 384 | 377 | | |

| Applied | | | | | Average | |
|---|---|---|---|---|---|---|
| Voltage | Trial # | | | | Activation | Standard |
| (V) | 46-1 | 46-2 | 46-3 | n/a | Time (s) | Deviation (s) |
| −20 | Activation times (seconds) | | | | 616.3 | 70.4 |
| | 646 | 667 | 536 | n/a | | |

The partially open electrochemical aperture 150b permits the lithium containing catholyte 144 to begin to fill the anolyte chamber 164b. As the lithium containing catholyte 144 reaches the lithium containing anode 160 that resides in the anolyte chamber 164b, an ionic pathway indicated by arrows 144a is established between the lithium containing cathode 140 and the lithium containing anode 160 via the partially filled the anolyte chamber 164b, as seen in FIGS. 4A-4B. The establishment of the ionic pathways indicated by arrows 144a between the lithium containing catholyte 144 and the lithium containing anode 160 can be characterized by attaching an inactive load 120, such as an unilluminated light-emitting diode (LED), to the lithium containing cathode 142 and lithium containing anode 160 with load leads 122. The instance that the ionic pathways indicated by arrows 144a between the lithium containing catholyte 144 and the lithium containing anode 160 is established, the inactive load 120, such as an unilluminated light-emitting diode (LED), will become an active load 125, such as an illuminated light-emitting diode (LED). The elapsed time starting from using a power source 110 to apply a current or voltage, through closed activation switch 130a and activation leads 132, the between the lithium containing cathode 140 and the closed electrochemical aperture 150 until the instance in which the inactive load 120 becomes an active load 125 can be used to quantify the initial activation time, known as the onset time. Table I summarizes the activation times achieved by applying voltages of 5V, 11V, 15V and 20V in numerous trials while using 16 μm thickness aluminum foils as the Electrochemical Apertures. The activation times ranged from approximately 300 to greater than 600 sec.

### Working Example II

A reserve battery 100 of the instant invention with a closed aperture 150 consisting of 12.5 μm tin foil (Goodfellow Corp., 97.4%) aperture in a disc diameter of approximately 1.2-1.3 cm, containing a lithium containing catholyte 144 consisting of 1M LiPF₆ in a 3:7 volume mixture of ethylene carbonate and ethyl methyl carbonate, respectively (MTI Corp) and a lithium containing cathode 140 LiFePO₄ (MTI Corp 93% loading). The power source 110 was used to apply a current or voltage, through closed activation switch 130 and activation leads 132, between the lithium containing cathode 140 and the closed electrochemical aperture 150 to initiate formation of openings in the electrochemical aperture 150b.

The partially open electrochemical aperture 150b permits the lithium containing catholyte 144 to begin to fill the anolyte chamber 164b. As the lithium containing catholyte 144 reaches the lithium containing anode 160 that resides in the anolyte chamber 164b, an ionic pathway indicated by arrows 144a is established between the lithium containing cathode 140 and the lithium containing anode 160 via the partially filled the anolyte chamber 164b, as seen in FIGS. 4A-4B. The establishment of the ionic pathways indicated by arrows 144a between the lithium containing catholyte 144 and the lithium containing anode 160 can be characterized by attaching an inactive load 120, such as an unilluminated light-emitting diode (LED), to the lithium containing cathode 142 and lithium containing anode 160 with load leads 122. The instance that the ionic pathways indicated by arrows 144a between the lithium containing catholyte 144 and the lithium containing anode 160 is established, the inactive load 120, such as an unilluminated light-emitting diode (LED), will become an active load 125, such as an illuminated light-emitting diode (LED). The elapsed time starting from using a power source 110 to apply a current or voltage, through closed activation switch 130a and activation leads 132, the between the lithium containing cathode 140 and the closed electrochemical aperture 150 until the instance in which the inactive load 120 becomes an active load 125 can be used to quantify the initial activation time, known as the onset time. Table II summarizes the activation times achieved by applying voltages of 5V, 11V, 15V and 20V in numerous trials while using 12.5 μm thickness tin foils as the Electrochemical Apertures. The activation times ranged from approximately 300 to greater than 500 sec.

TABLE II
Summary of activation times using a 12.5 μm thickness
tin foil electrochemical aperture

| Applied | | | | | | Average | |
|---|---|---|---|---|---|---|---|
| Voltage | Trial # | | | | | Activation | Standard |
| (V) | 67-1 | 67-2 | 67-3 | n/a | n/a | Time (s) | Deviation (s) |
| −5 | Activation times (seconds) | | | | | 527.7 | 91.4 |
| | 425 | 558 | 600 | n/a | n/a | | |
| Applied | | | | | | Average | |
| Voltage | Trial # | | | | | Activation | Standard |
| (V) | 65-1 | 65-2 | 65-3 | n/a | n/a | Time (s) | Deviation (s) |
| −11 | Activation times (seconds) | | | | | 301 | 25.1 |
| | 325 | 275 | 303 | n/a | n/a | | |

| Applied | | | | | | Average | |
|---|---|---|---|---|---|---|---|
| Voltage | Trial # | | | | | Activation | Standard |
| (V) | 68-1 | 68-3 | 69-1 | 69-2 | 69-3 | Time (s) | Deviation (s) |
| −15 | Activation times (seconds) | | | | | 159.8 | 22.5 |
| | 152 | 191 | 166 | 161 | 129 | | |

| Applied | | | | | | Average | |
|---|---|---|---|---|---|---|---|
| Voltage | Trial # | | | | | Activation | Standard |
| (V) | 66-1 | 66-2 | 66-3 | n/a | n/a | Time (s) | Deviation (s) |
| −20 | Activation times (seconds) | | | | | 428.7 | 134.5 |
| | 293 | 431 | 562 | n/a | n/a | | |

### Working Example III

A reserve battery 100 of the instant invention with a closed aperture 150 consisting of 12.5 μm tin foil (Goodfellow Corp., 97.4%) aperture in a disc diameter of approximately 1.2-1.3 cm, containing a lithium containing catholyte 144 consisting of 1M LiPF₆ in a 3:7 volume mixture of ethylene carbonate and ethyl methyl carbonate, respectively (MTI Corp) and a lithium containing cathode 140, such as LiFePO₄ (MTI Corp 93% loading). The power source 110 was used to apply a current or voltage, through closed activation switch 130 and activation leads 132 between the lithium containing cathode 140 and the closed electrochemical aperture 150 to precondition or pre-lithiate the closed electrochemical aperture 150 by inducing lithium incorporation into the closed electrochemical aperture 150. The preconditioning time is selected such that the electrochemical aperture 150 maintains mechanical integrity and shortens the subsequent activation time. The preconditioning period is terminated by disconnecting the power source 110 by effecting an open activation switch 130.

A subsequent rest period follows the preconditioning period, in which the closed electrochemical aperture 150 maintains physical separation between the lithium containing catholyte 144 and the electrolyte-free anolyte chamber 164. The duration of the storage or rest period ranges from seconds to years and this rest period concludes upon a subsequent application of a current or voltage from the power source 110, through closed activation switch 130a and activation leads 132, between the lithium containing cathode 140 and the lithium containing closed electrochemical aperture 150, to initiation formation of openings in the electrochemical aperture 150b.

The partially open electrochemical aperture 150b permits the lithium containing catholyte 144 to begin to fill the anolyte chamber 164b. As the lithium containing catholyte 144 reaches the lithium containing anode 160 that resides in the anolyte chamber 164b, an ionic pathway indicated by arrows 144a is established between the lithium containing cathode 140 and the lithium containing anode 160 via the partially fill the anolyte chamber 164b, as seen in FIGS. 4A-4B. The establishment of the ionic pathways indicated by arrows 144a between the lithium containing catholyte 144 and the lithium containing anode 160 can be characterized by attaching an inactive load 120, such as an unilluminated light-emitting diode LED, to the lithium containing cathode 142 and lithium containing anode 160 with load leads 122. The instance that the ionic pathways indicated by arrows 144a between the lithium containing catholyte 144 and the lithium containing anode 160 is established, the inactive load 120, such as an unilluminated light-emitting diode (LED), will become an active load 125, such as an illuminated light-emitting diode (LED). The elapsed time starting from using a power source 110 to apply a current or voltage, through closed activation switch 130a and activation leads 132, the between the lithium containing cathode 140 and the closed electrochemical aperture 150 until the instance in which the inactive load 120 becomes an active load 125 can be used to quantify the initial activation time, known as the onset time. Table II summarizes activation times after pre-conditioning of a 12.5 μm thickness tin foil electrochemical aperture for 145 sec and after a rest or storage period of 25 hrs. After the preconditioning step and storage time, the onset of activation is observed after 1 sec.

With continued application of a current or voltage through closed activation switch 130a and activation leads 132, the between the lithium containing cathode 140 and the partially open electrochemical aperture 150b, additional openings form in the partially open electrochemical aperture 150b and/or existing opening(s) on the partially open electrochemical aperture 150b enlarge, leading to new ionic pathways, similar to the ionic pathways indicated by arrows 144a, and/or larger ionic pathway(s) between the lithium containing cathode 140 and the lithium containing anode 160, permitting more lithium containing catholyte 144 to enter the partially filled anolyte chamber 164b until the volume of the lithium containing catholyte 144 completely occupies the volume originally defined by the electrolyte-free anolyte chamber 164, and becomes the fully filled lithium containing anolyte chamber 164a and is known as the fully filled time. As seen in Table III, after the preconditioning step and storage time, the 12.5 μm thickness tin foil electrochemical aperture in a fully filled activated state after 19 sec.

TABLE III
Summary of activation time using a 12.5 μm thickness tin foil electrochemical
aperture after a preconditioning period and after a rest period.

| | | | | Activation Period | | | |
|---|---|---|---|---|---|---|---|
| Pre-Conditioning Period | | | Rest | | | Activation: | Activation: |
| Trial | Voltage | Duration | Period | Trial | Voltage | Onset | fully filled |
| # | (V) | (s) | (hours) | # | (V) | time (s) | time (s) |
| 85-1-1 | −15 | 145 | 25 | 85-1-2 | −15 | 1 | 19 |

### Working Example IV

A reserve battery 100 of the instant invention with a closed aperture 150b, FIG. 6A consisting of 12.5 μm tin foil (Goodfellow Corp., 97.4%) aperture in a disc diameter of approximately 1.2-1.3 cm, containing a lithium containing catholyte 144 consisting of 1M LiPF₆ in a 1:1 volume mixture of ethylene carbonate and ethyl methyl carbonate (Sigma Aldrich) and a lithium containing cathode 140 LiFePO₄ (MTI Corp 93% loading). The power source 110 was used to apply a current or voltage, through closed activation switch 130 and activation leads 132, between the lithium containing cathode 140 and the closed electrochemical aperture 150 to initiate formation of openings in the electrochemical aperture 150b through oxidation or dissolution of the metallic aperture wherein metal ions (M⁺ⁿ) enter the catholyte 144. One skilled in the art recognizes that said metal ions may be of valence 2, 3 and the like. Said metallic aperture may comprise materials such as tin, copper or other material subject to electrochemical oxidation or dissolution.

The partially open electrochemical aperture 150b permits the lithium containing catholyte 144 to begin to fill the anolyte chamber 164b. As the lithium containing catholyte 144 reaches the lithium containing anode 160 that resides in the anolyte chamber 164b, an ionic pathway indicated by arrows 144a is established between the lithium containing cathode 140 and the lithium containing anode 160 via the partially filled the anolyte chamber 164b, as seen in FIGS. 6A-6B. The establishment of the ionic pathways indicated by arrows 144a between the lithium containing catholyte 144 and the lithium containing anode 160 can be characterized by attaching an inactive load such as an unilluminated light-emitting diode (LED), to the lithium containing cathode 142 and lithium containing anode 160 with load leads. The instance that the ionic pathways indicated by arrows 144a between the lithium containing catholyte 144 and the lithium containing anode 160 is established, the inactive load such as an unilluminated light-emitting diode (LED), will become an active load such as an illuminated light-emitting diode (LED). The elapsed time starting from using a power source 110 to apply a current or voltage, through closed activation switch 130a and activation leads 132, the between the lithium containing cathode 140 and the closed electrochemical aperture 150 until the instance in which the inactive load becomes an active load can be used to quantify the initial activation time, known as the onset time. TABLE IV summarizes the activation times achieved by applying oxidative voltages of +5V and +15V in numerous trials while using 12.5 μm thickness tin foils as the Electrochemical Apertures. The activation times ranged from approximately 137 to 231 sec.

TABLE IV
Summary of activation times using a 12.5 μm thickness
tin foil electrochemical aperture under conditions
of electrochemical oxidation/dissolution.

| | Applied | Average Activation | Standard |
|---|---|---|---|
| Test ID | Voltage (V) | Time (s) | Deviation |
| 60-1 | +5 | 231 | N/A |
| 56-1 and 57-1 | +15 | 184 | 66 |

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A battery comprising:
a first chamber with a first electrode;
a second chamber with a second electrode; and
an intercalation membrane between the first chamber and the second chamber configured to retain an electrolyte in the first chamber and to accept therein migrating ions of the electrolyte in the presence of an electrical field and lose mechanical integrity permitting the electrolyte to enter the second chamber.

2. The battery of claim 1 in which the first electrode is a cathode.

3. The battery of claim 1 in which the second electrode is an anode.

4. The battery of claim 1 in which the electrolyte is a lithium containing catholyte and the migrating ions are lithium ions.

5. The battery of claim 4 in which the first electrode and second electrode include lithium.

6. The battery of claim 1 in which the intercalation membrane includes aluminum foil.

7. The battery of claim 1 further including a power source connected to the intercalation membrane for generating the electrical field.

8. The battery of claim 7 further including a switch for selectively connecting the intercalation membrane to the power source.

9. The battery of claim 1 further including supports for the intercalation membrane.

10. The battery of claim 1 in which the first electrode includes a first connector and the second electrode includes a second connector for first and second load leads, respectively.

11. The battery of claim 1 further including a battery separator between the first electrode and the second electrode for allowing ions of the electrolyte to pass bidirectionally between the first and second electrodes.

12. The battery of claim 1 in which the membrane is pre-calcilated with said ions.

13. The battery of claim 12 in which the intercalation membrane is configured to de-calcilate in the presence of the electrical field and lose mechanical integrity permitting the electrolyte to enter the second chamber.

14. A reserve battery comprising:
a first electrode;
a second electrode;
an electrolyte;
a membrane between the first electrode and the second electrode and configured to have two states:
a first cohesive state blocking said electrolyte from contacting the second electrode, and
a second losing cohesion state permitting pass-through of the electrolyte to the second electrode; and
a power source connectable to the membrane to change the membrane from the first state to the second state to deliver the electrolyte to the second electrode.

15. The battery of claim 14 in which, in the second state, the membrane is injected with ions, has ions removed from it, or is electrochemically oxidated or dissolutioned.

16. The battery of claim 14 in which the first electrode is a cathode.

17. The battery of claim 14 in which the second electrode is an anode.

18. The battery of claim 14 in which the electrolyte is a lithium containing catholyte.

19. The battery of claim 18 in which the first electrode and second electrode include lithium.

20. The battery of claim 14 in which the membrane includes aluminum foil.

21. The battery of claim 14 further including a switch for selectively connecting the membrane to the power source.

22. The battery of claim 14 further including supports for the membrane.

23. The battery of claim 14 in which the first electrode includes a first connector and the second electrode includes a second connector for first and second load leads, respectively.

24. The battery of claim 14 further including a battery separator between the first electrode and the second electrode for allowing ions of the electrolyte to pass bidirectionally between the first and second electrodes.

25. The battery of claim 14 in which the membrane is pre-calcilated with said ions.

26. A method of activating a battery, the method comprising:
placing a cohesive membrane in the battery to define first and second 2 chambers each including an electrode;
placing an electrolyte in the first chamber;
applying an electrical field to the membrane until it loses cohesion and electrolyte passes from the first chamber to the second chamber providing power access to the electrodes.

27. The method of claim 26 in which applying the electrical field causes ions to inject into the membrane, causes ions to leave the membrane, or electrochemically oxidizes or dissolutions the membrane.

28. The method of claim 26 in which one electrode is a cathode.

29. The method of claim 26 in which the other electrode is an anode.

30. The method of claim 26 in which the electrolyte is a lithium containing catholyte.

31. The method of claim 30 in which both electrodes include lithium.

32. The method of claim 26 in which the membrane includes aluminum foil.

33. The method of claim 26 further including using a power source connected to the membrane for generating the electrical field.

34. The method of claim 26 further including selectively connecting the membrane to the power source.

35. The method of claim 26 further including supporting the intercalation membrane.

36. The method of claim 26 further including placing a battery separator between the electrodes and allowing ions of the electrolyte to pass bidirectionally between the first and second electrodes.

37. The method of claim 26 further including pre-calcinating the membrane with said ions.
